(19) United States
(12) Patent Application Publication
(10) Pub. No.: US 2023/0077676 A1
(43) Pub. Date: Mar. 16, 2023

(54) INKJET RECORDING APPARATUS AND METHOD OF CONTROLLING THE SAME

(71) Applicant: CANON KABUSHIKI KAISHA, Tokyo (JP)

(72) Inventor: Koki Shimada, Kawasaki-shi (JP)

(21) Appl. No.: 18/056,212

(22) Filed: Nov. 16, 2022

Related U.S. Application Data
(62) Division of application No. 16/930,115, filed on Jul. 15, 2020.

(30) Foreign Application Priority Data
Jul. 30, 2019 (JP) 2019-140180

(51) Int. Cl. B41J 2/165; B41J 2/14

(52) U.S. Cl. CPC B41J 2/16547; B41J 2/14; B41J 2/16508; B41J 2202/20; B41J 2002/1655

(57) ABSTRACT

An inkjet recording apparatus includes a recording head including an ejection port surface and a nozzle cover, wherein the ejection port surface includes an array of a plurality of ejection ports through which ink is to be ejected, and wherein the nozzle cover protrudes downward with respect to the ejection port surface and is disposed on an outer side of the ejection port surface, a wiper unit capable of wiping the ejection port surface and the nozzle cover, and a moving mechanism configured to move the wiper unit relative to the ejection port surface, wherein the wiper unit has a notch at a position at which the notch faces a first step portion between the ejection port surface and the nozzle cover when the wiper unit performs wiping while the wiper unit is moved by the moving mechanism.

### CROSS REFERENCE TO RELATED APPLICATIONS

The present application is a divisional of U.S. patent application Ser. No. 16/930,115, filed on Jul. 15, 2020, which claims the benefit of Japanese Patent Application No. 2019-140180, filed Jul. 30, 2019, all of which are hereby incorporated by reference herein in their entireties.

### BACKGROUND

### Field

The present disclosure relates to an inkjet recording apparatus and a method of controlling the inkjet recording apparatus.

### Description of the Related Art

Japanese Patent Laid-Open No. 2018-122501 discloses an inkjet recording apparatus including a wiper that wipes an ejection port array of a recording head, and a tab wiper that wipes the entirety of an ejection port surface including the ejection port array. Thus, the ink remaining on the ejection port array and the ink scattered on a tab surface can be wiped.

When the recording head repeatedly performs a recording operation, ink may adhere to a nozzle cover that covers an outer side of the tab surface because the ink ejected from the recording head flies off. In a case where the adhering ink accumulates, the ink may contaminate a recording medium. With the configuration disclosed in Japanese Patent Laid-Open No. 2018-122501, however, the wiper or the tab wiper is not able to wipe the nozzle cover. The recording medium may not be prevented from being contaminated.

### SUMMARY

The present disclosure provides information concerning an inkjet recording apparatus capable of preventing a recording medium from being contaminated by performing wiping to an outer side of an ejection port surface.

According to an aspect of the present disclosure, an inkjet recording apparatus includes a recording head including an ejection port surface and a nozzle cover, wherein the ejection port surface includes an array of a plurality of ejection ports through which ink is to be ejected, and wherein the nozzle cover protrudes downward with respect to the ejection port surface and is disposed on an outer side of the ejection port surface, a wiper unit capable of wiping the ejection port surface and the nozzle cover, and a moving mechanism configured to move the wiper unit relative to the ejection port surface, wherein the wiper unit has a notch at a position at which the notch faces a first step portion between the ejection port surface and the nozzle cover when the wiper unit performs wiping while the wiper unit is moved by the moving mechanism.

Further features of the present disclosure will become apparent from the following description of exemplary embodiments with reference to the attached drawings.

### BRIEF DESCRIPTION OF THE DRAWINGS

FIG. 1 is a schematic perspective view of an inkjet recording apparatus according to a first embodiment.

FIG. 2 is a block diagram of a control unit that controls the inkjet recording apparatus according to the first embodiment.

FIG. 3 is a perspective view of a maintenance unit of the inkjet recording apparatus according to the first embodiment.

FIG. 4 is a perspective view of a recording head of the inkjet recording apparatus according to the first embodiment.

FIG. 5 is a schematic view illustrating in detail correspondence between the recording head and a wiper unit of the inkjet recording apparatus according to the first embodiment.

FIGS. 6A and 6B are side views illustrating correspondence between the recording head and the wiper unit in the inkjet recording apparatus according to the first embodiment.

FIG. 7 is a view schematically illustrating a moving path of the wiper unit when the recording head is located at a first position in the inkjet recording apparatus according to the first embodiment.

FIG. 8 is a view schematically illustrating a moving path of the wiper unit when the recording head is located at a second position in the inkjet recording apparatus according to the first embodiment.

FIG. 9 is a flowchart indicating a normal wiping sequence of the inkjet recording apparatus according to the first embodiment.

FIG. 10 is a flowchart indicating a wide wiping sequence of the inkjet recording apparatus according to the first embodiment.

FIG. 11 is a view illustrating a display panel of the inkjet recording apparatus according to the first embodiment.

FIG. 12 is a schematic perspective view of an inkjet recording apparatus according to a second embodiment.

FIG. 13 is a perspective view of a maintenance unit of the inkjet recording apparatus according to the second embodiment.

FIG. 14 is a side view illustrating correspondence between a recording head and a wiper unit of the inkjet recording apparatus according to the second embodiment.

FIG. 15 is a view schematically illustrating a moving path of the wiper unit when the recording head is located at a first position in the inkjet recording apparatus according to the second embodiment.

FIG. 16 is a view schematically illustrating a moving path of the wiper unit when the recording head is located at a second position in the inkjet recording apparatus according to the second embodiment.

### DESCRIPTION OF THE EMBODIMENTS

Embodiments of the present disclosure are described below with reference to the drawings. However, the following embodiments do not limit the present disclosure. Not all features of the combination described in any one of the embodiments are essential for the solutions of the present disclosure. In addition, the relative arrangement and shapes of the components described in the embodiments are merely examples, and do not limit the scope of the present disclosure.

### First Embodiment

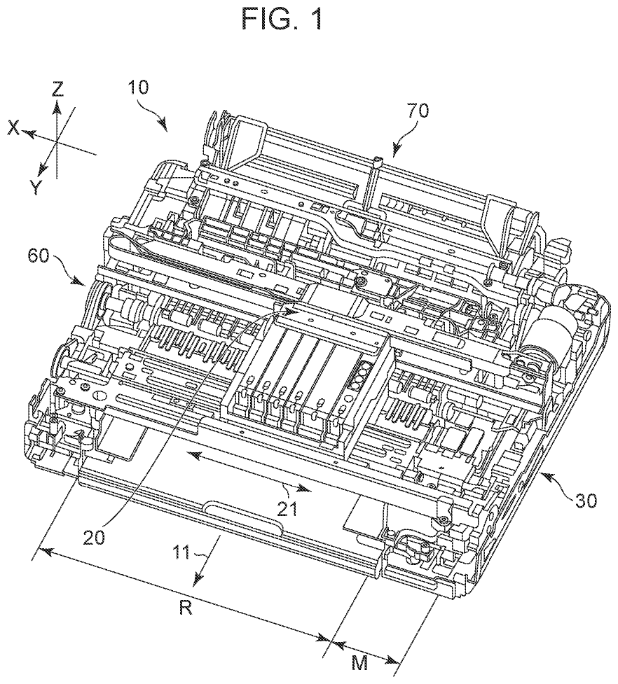

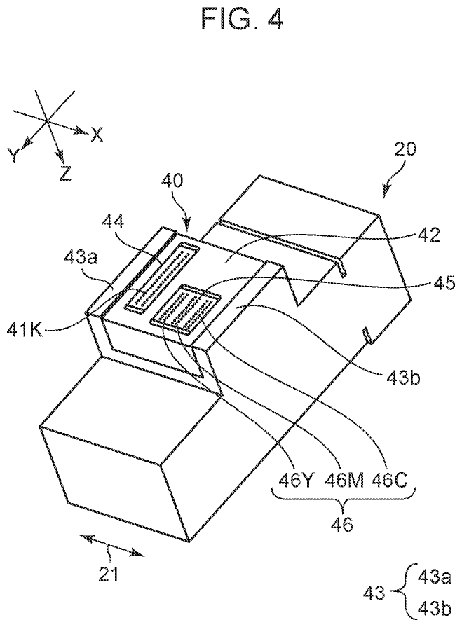

FIG. 1 is a schematic perspective view illustrating an overview of an inkjet recording apparatus (hereinafter, recording apparatus) 10 according to a first embodiment. The recording apparatus 10 includes a carriage 20 on which a recording head 40 (see FIG. 4) is mounted, a feed unit 70, a conveyance drive section 60, and a maintenance unit 30. The carriage 20 moves to reciprocate in a main scanning direction 21 that is parallel to an X direction.

The feed unit 70 feeds stacked recording media one by one by a feed roller to the inside of a main body of the recording apparatus 10. The conveyance drive section 60 is disposed on one end side in the main scanning direction 21, and rotates a conveyance roller to convey the recording medium fed by the feed unit 70 in a conveyance direction 11. The conveyance direction 11 is parallel to a Y direction indicated in FIG. 1, and intersects with the main scanning direction 21. In the present embodiment, the conveyance direction 11 is orthogonal to the main scanning direction 21.

The recording head 40 is mounted on a bottom portion of the carriage 20 to face the recording medium to be conveyed, and has a plurality of ejection ports through which ink is ejected. The recording head 40 ejects ink droplets while moving in the main scanning direction 21, thereby performing a recording operation of recording an image for one band on the recording medium. When the image for one band is recorded, the recording medium is conveyed by the conveyance drive section 60 in the conveyance direction 11 by a predetermined amount corresponding to one band (intermittent conveyance operation). By repeating the recording operation for one band and the intermittent conveyance operation, an image is entirely recorded on the recording medium. Note that the recording head 40 may be detachably attachable to the carriage 20.

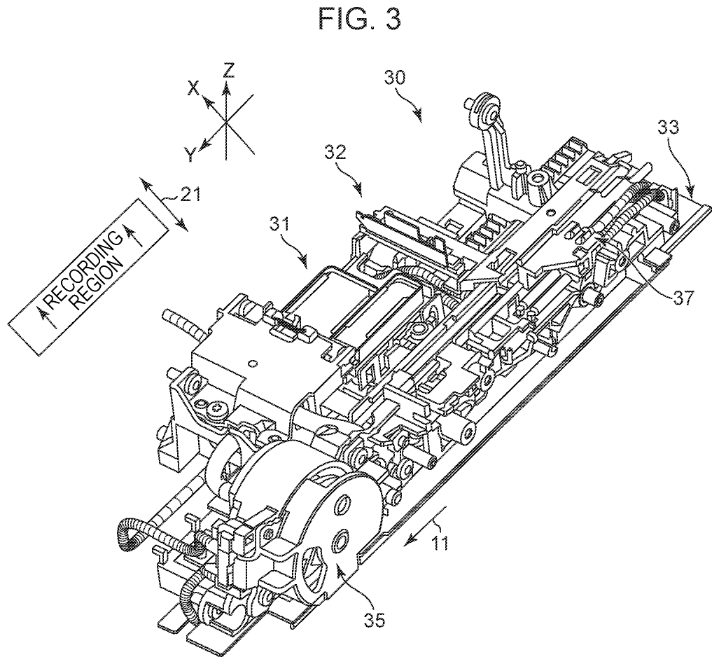

The maintenance unit 30 is a mechanism that performs a recovery operation of maintaining and recovering ejection performance of the recording head 40, and includes a cap 31 and a wiper unit 32 (see FIG. 3). The maintenance unit 30 is disposed outside a recording region R where the recording head 40 performs the recording operation and inside a scanning region where the carriage 20 moves (recovery region M).

The recovery operation of the maintenance unit 30 includes a preliminary ejection operation, a wiping operation, and an ink suction operation. The preliminary ejection operation is an operation of ejecting ink that does not contribute to the recording operation from the recording head 40 toward the cap 31. The wiping operation is an operation of wiping an ejection port surface having ejection ports of the recording head 40 with the wiper unit 32. The ink suction operation is an operation of sucking ink from the ejection ports of the recording head 40 with a suction unit.

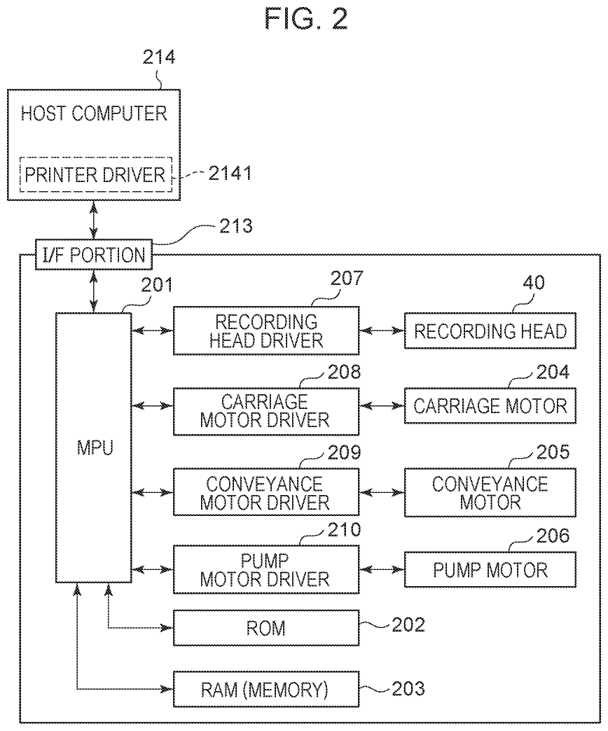

The conveyance drive section 60 includes a conveyance motor 205 (see FIG. 2) that rotates the conveyance roller, and is disposed on a side opposite to the maintenance unit 30 in the main scanning direction 21. That is, in the present embodiment, the conveyance drive section 60 is disposed on the left side and the maintenance unit 30 is disposed on the right side when viewed from a front surface of the recording apparatus 10. The driving in the maintenance unit 30 is transferred by a drive train from the conveyance drive section 60. When the recording apparatus 10 receives a recording command, the recording head 40 starts the recording operation from a side near the maintenance unit 30, moves toward a side near the conveyance drive section 60, and returns toward the side near the maintenance unit 30.

FIG. 2 is a block diagram of a control unit that controls the recording apparatus 10. A micro processing unit (MPU) 201 controls the entirety of the recording apparatus 10, such as the operations and data processing of respective units. A read-only memory (ROM) 202 stores a program that is executed by the MPU 201 and various data. A random access memory (RAM) 203 temporarily stores data of a process that is executed by the MPU 201 and data received from a host computer 214.

The recording head 40 is controlled by a recording head driver 207. A carriage motor 204 that drives the carriage 20 is controlled by a carriage motor driver 208. The conveyance motor 205 that constitutes the conveyance drive section 60 is controlled by a conveyance motor driver 209. The feed roller that constitutes the feed unit 70 and a pump 35 (see FIG. 3) that is the suction unit of the maintenance unit 30 are driven by a pump motor 206. The pump motor 206 is controlled by a pump motor driver 210.

The host computer 214 is provided with a printer driver 2141 to collect a recording image and recording information such as the quality of the recording image and communicate with the recording apparatus 10 when a user gives a command on execution of the recording operation. The MPU 201 executes reception and transmission of a recording image or the like from and to the host computer 214 via an interface (I/F) portion 213.

FIG. 3 is a perspective view of the maintenance unit 30. The maintenance unit 30 includes the cap 31, the wiper unit 32, a cam slider 33, the pump 35, and an air valve lever 37.

The cap 31 is made of a flexible material, and is configured to be movable between a capping position at which the cap 31 covers the ejection port surface of the recording head 40 and a separate position at which the cap 31 does not cover the ejection port surface. The cap 31 is connected to the pump 35. When the pump 35 is driven by the pump motor 206 in a state where the cap 31 is located at the capping position, the pressure in the cap 31 becomes a negative pressure and the ink in the cap 31 is sucked (ink suction operation). The cap 31 and the pump 35 are connected via a cap tube. The ink sucked by the ink suction operation is collected in a waste ink tank (not illustrated).

The air valve lever 37 is connected to the cap 31, and is switched between a communication state in which the inside of the cap 31 communicates with the air and a non-communication state in which the inside of the cap 31 does not communicate with the air. Specifically, when the air valve lever 37 is in contact with an air valve seal (not illustrated) made of rubber or the like, the inside of the cap 31 does not communicate with the air. When the air valve lever 37 is not in contact with the air valve seal, the inside of the cap 31 communicates with the air. The cap 31 and the air valve lever 37 are connected via an air valve tube.

The cam slider 33 is driven by the conveyance drive section 60 and performs a reciprocation operation of reciprocating in the conveyance direction 11. When the cam slider 33 performs the reciprocation operation, cam surfaces that constitute the cam slider 33 come into contact with follower surfaces of respective members in conjunction with the operation, and the respective members can operate independently from one another. In the present embodiment, with the reciprocation operation of the cam slider 33, the cap 31, the wiper unit 32, and the air valve lever 37 are independently operated.

In the present embodiment, the cam slider 33 is employed as a cam mechanism; however, the cam mechanism is not limited to the cam mechanism that performs the reciprocation operation, and may be a cam mechanism that performs a rotation operation. Furthermore, the maintenance on the recording head 40 can be performed as far as the maintenance unit 30 includes at least the cap 31 and the wiper unit 32. The maintenance unit 30 may include not all the above-described members. That is, the present embodiment is not limited to the configuration that uses all the above-described members of the maintenance unit 30.

A configuration of the carriage 20 in the recording apparatus 10 is described next. FIG. 4 is a perspective view of the carriage 20 on which the recording head 40 is mounted when viewed from below. The ejection port surface of the recording head 40 includes a first chip surface 44 and a second chip surface 45 in which a plurality of ejection ports are arrayed, and a tab surface 42 surrounding the peripheries of the first chip surface 44 and the second chip surface 45.

The first chip surface 44 has an ejection port array 41K to eject black ink. The second chip surface 45 has an ejection port array 46C to eject cyan ink, an ejection port array 46M to eject magenta ink, and an ejection port array 46Y to eject yellow ink. Each ejection port array is arrayed in the Y direction (conveyance direction 11).

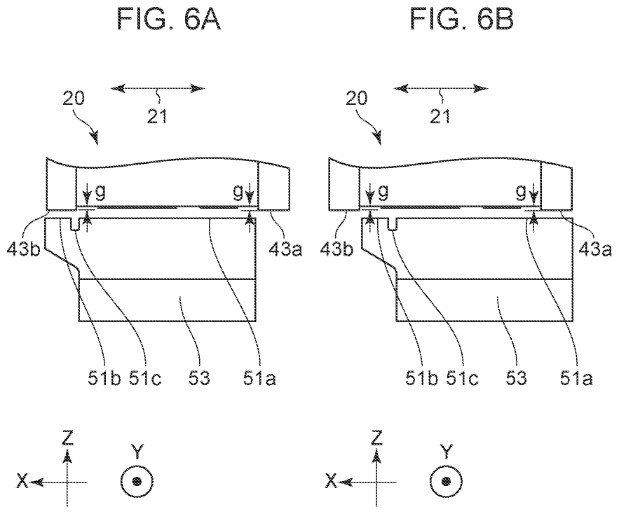

The recording head 40 includes a first nozzle cover 43a and a second nozzle cover 43b that cover the outer sides of the tab surface 42 in the main scanning direction 21. The second nozzle cover 43b is disposed at a position closer than the first nozzle cover 43a to the recording region R in the main scanning direction 21. Hereinafter, the first nozzle cover 43a and the second nozzle cover 43b are also collectively referred to as nozzle cover 43. The nozzle cover 43 has a lower surface that protrudes downward with respect to the tab surface 42. Thus, a step portion g (see FIG. 6) is provided between the nozzle cover 43 and the tab surface 42 in the gravity direction.

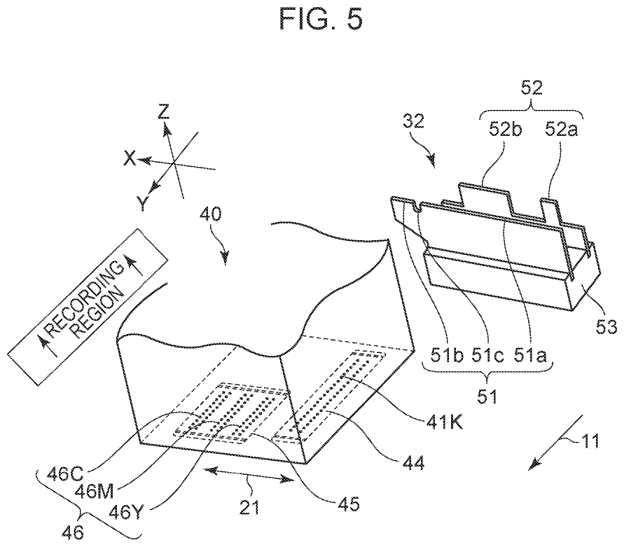

FIG. 5 is a perspective view illustrating correspondence between the recording head 40 and the wiper unit 32 in detail. The wiper unit 32 moves in the conveyance direction 11 by the operation of the cam slider 33, thereby performing a wiping operation. Specifically, the cam slider 33 moves in a direction opposite to the conveyance direction 11 by the driving of the conveyance drive section 60, and hence the wiper unit 32 moves in the conveyance direction 11. Thus, the conveyance drive section 60 and the cam slider 33 function as a moving mechanism of the wiper unit 32.

The wiper unit 32 includes a first wiper 51 and a second wiper 52 that is disposed upstream of the first wiper 51 in the conveyance direction 11. The first wiper 51 and the second wiper 52 have blade-like shapes and are held by a wiper holder 53.

The first wiper 51 includes a first contact portion 51a, a second contact portion 51b, and a notch 51c. The second contact portion 51b is provided on a side closer than the first contact portion 51a to the recording region R. The notch 51c is provided between the first contact portion 51a and the second contact portion 51b. The first contact portion 51a has a length in the main scanning direction 21 with which the first contact portion 51a is capable of wiping the tab surface 42. The second contact portion 51b has a length in the main scanning direction 21 with which the second contact portion 51b is capable of wiping the second nozzle cover 43b.

The second wiper 52 includes a third contact portion 52a and a fourth contact portion 52b. The third contact portion 52a has a length in the main scanning direction 21 with which the third contact portion 52a is capable of wiping the ejection port array 41K. The fourth contact portion 52b has a length in the main scanning direction 21 with which the fourth contact portion 52b is capable of wiping all the ejection port arrays 46C, 46M, and 46Y.

The wiping operation according to the present embodiment is described next. In the present embodiment, the carriage 20 moves in the main scanning direction 21, and hence the wiping operation can be executed at two positions when the recording head 40 is located at a first position and when the recording head 40 is located at a second position closer than the first position to the recording region R. The first position and the second position are positions in the recovery region M. When the recording head 40 is at the first position, the recording head 40 is capped with the cap 31.

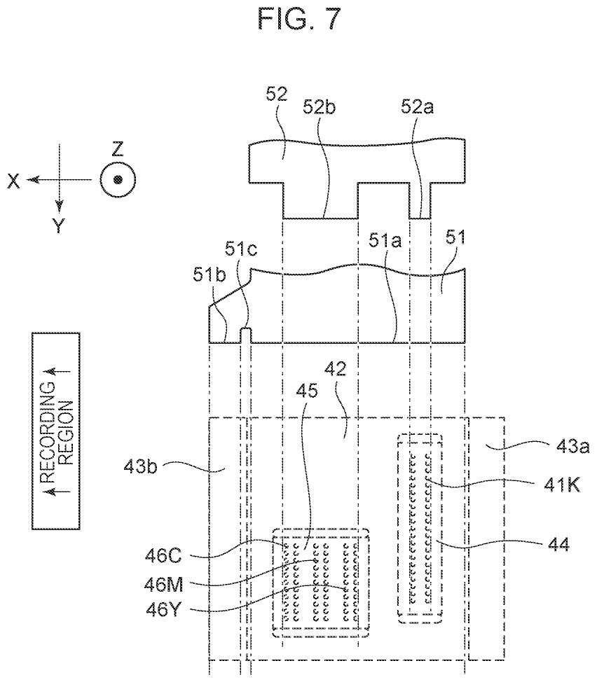

FIGS. 6A and 6B are side views illustrating correspondence between the carriage 20 and the first wiper 51 when the wiping operation is performed. FIG. 6A illustrates a state where the recording head 40 is located at the first position. FIG. 7 is a view schematically illustrating a moving path of the wiper unit 32 relative to the recording head 40 when the recording head 40 is located at the first position. The moving path of the wiper unit 32 is indicated by one-dot chain lines.

Wiping in the state where the recording head 40 is located at the first position is referred to as first wiping operation. When the recording head 40 is located at the first position, the first contact portion 51a of the first wiper 51 faces the tab surface 42, and the second contact portion 51b faces the second nozzle cover 43b. Thus, when the first wiping operation is performed, the first contact portion 51a wipes the entirety of the tab surface 42, and the second contact portion 51b wipes the second nozzle cover 43b.

Moreover, when the recording head 40 is located at the first position, the notch 51c of the first wiper 51 faces the step portion g between the tab surface 42 and the second nozzle cover 43b. Since the notch 51c is provided, the first wiper 51 does not ride onto the second nozzle cover 43b due to the step portion g, and the tab surface 42 can be properly wiped.

When the recording head 40 is located at the first position, the third contact portion 52a of the second wiper 52 faces the first chip surface 44, and the fourth contact portion 52b faces the second chip surface 45. Thus, when the first wiping operation is performed, the third contact portion 52a wipes the first chip surface 44, and the fourth contact portion 52b wipes the second chip surface 45.

The above-described first wiping operation is executed as a normal wiping sequence after completion of the recording operation by the recording head 40 or after the ink suction operation of the maintenance unit 30. Note that the first nozzle cover 43a does not face any one of the first wiper 51 and the second wiper 52 when the recording head 40 is located at the first position. Thus, even when the first wiping operation is performed, the first nozzle cover 43a is not wiped.

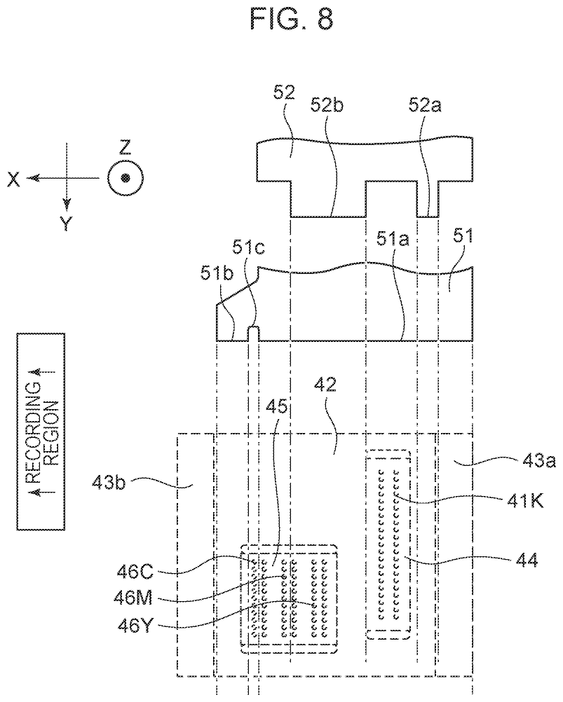

FIG. 6B illustrates a state where the recording head 40 is located at the second position that is closer than the first position to the recording region R. FIG. 8 is a view schematically illustrating a moving path of the wiper unit 32 relative to the recording head 40 when the recording head 40 is located at the second position. The moving path of the wiper unit 32 is indicated by one-dot chain lines.

Wiping in the state where the recording head 40 is located at the second position is referred to as second wiping operation. When the recording head 40 is located at the second position, a portion of the first contact portion 51a of the first wiper 51 faces the first nozzle cover 43a. Thus, when the second wiping operation is performed, the first contact portion 51a wipes the first nozzle cover 43a. That is, the first nozzle cover 43a that is not wiped by the first wiping operation is wiped by the second wiping operation.

In the present embodiment, the second wiping operation is executed if the amount of ink ejected from the recording head 40 since the last second wiping operation exceeds a predetermined value. However, it is not limited thereto. For example, the second wiping operation may be executed if the total number of recorded sheets since the last second wiping operation exceeds a predetermined number of sheets.

As described above, the second nozzle cover 43b close to the recording region R is wiped by the first wiper 51, and the first nozzle cover 43a far from the recording region R is wiped after the position of the carriage 20 has been changed to a position close to the recording region R. That is, without increasing the size of the scanning region of the carriage 20 or without excessively increasing the size of the first wiper 51 in the main scanning direction, wiping can be performed to the outer sides of the ejection port surface. Accordingly, the recording apparatus 10 can be downsized in the main scanning direction, and the recording apparatus 10 capable of performing wiping to the outer sides of the ejection port surface can be provided.

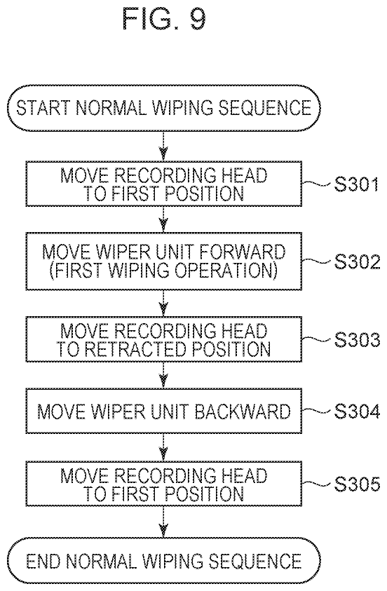

FIG. 9 is a flowchart indicating the normal wiping sequence. In the normal wiping sequence, the second wiping operation is not executed and only the first wiping operation is executed. In S301, the MPU 201 causes the carriage 20 to move to a position at which the recording head 40 is located at the first position, and then to stop the carriage 20.

In S302, the MPU 201 causes the cam slider 33 to operate, to move the wiper unit 32 (forward) in the conveyance direction 11. Along with the movement of the wiper unit 32, the first wiping operation is executed. That is, the entirety of the ejection port surface including the first chip surface 44, the second chip surface 45, and the tab surface 42, as well as the second nozzle cover 43b are wiped.

In S303, the MPU 201 causes the carriage 20 to move such that the recording head 40 is located at a retracted position at which the recording head 40 is retracted from the moving path of the wiper unit 32. That is, the carriage 20 moves from the recovery region M to the recording region R.

In S304, the MPU 201 causes the cam slider 33 to operate, to move the wiper unit 32 (backward) in a direction opposite to the conveyance direction 11 and to return the wiper unit 32 to the original position.

In S305, the MPU 201 causes the carriage 20 to move again to the position at which the recording head 40 is located at the first position, and then to stop the carriage 20. Thus, the normal wiping sequence is ended. In general, the recording head 40 is capped with the cap 31 and waits until the recording apparatus 10 receives the next recording command.

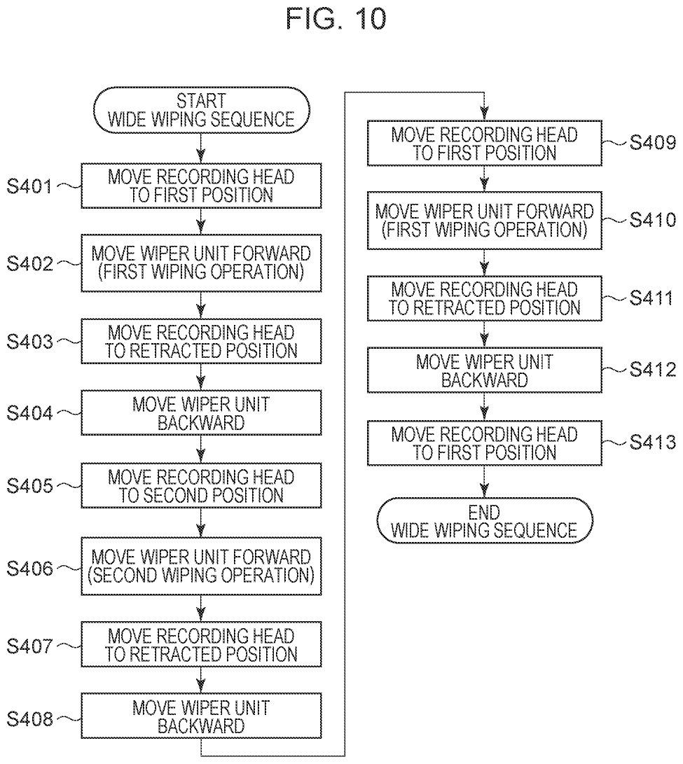

A wide wiping sequence including the second wiping operation is described next with reference to FIG. 10. In the wide wiping sequence, the recording head 40 is wiped three times in the order of the first wiping operation, the second wiping operation, and the first wiping operation. S401 to S404 are similar to S301 to S304 in FIG. 9. The first wiping operation for the first time is performed.

Then, in S405, the MPU 201 causes the carriage 20 to move to a position at which the recording head 40 is located at the second position, and then to stop the carriage 20.

In S406, the MPU 201 causes the cam slider 33 to operate, to move the wiper unit 32 (forward) in the conveyance direction 11. Along with the movement of the wiper unit 32, the second wiping operation is executed. That is, the first nozzle cover 43a is wiped.

In S407, the MPU 201 causes the carriage 20 to move such that the recording head 40 is located at a retracted position at which the recording head 40 is retracted from the moving path of the wiper unit 32. That is, the carriage 20 moves from the recovery region M to the recording region R.

In S408, the MPU 201 causes the cam slider 33 to operate, to move the wiper unit 32 (backward) in the direction opposite to the conveyance direction 11 and to return the wiper unit 32 to the original position.

In S409 to S413, the MPU 201 causes the first wiping operation for the second time to be executed on the recording head 40. Then, the wide wiping sequence is ended.

In this case, when the second wiping operation is executed in S405, end portions in the X direction (main scanning direction 21) of the first wiper 51 and the second wiper 52 come into contact with the ejection port arrays 41 and 46, and hence ink may bleed from the ejection ports. Executing the first wiping operation again after the second wiping operation has been executed can wipe the bleeding ink.

As described above, the normal wiping sequence is executed after the recording operation or the suction operation, and the wide wiping sequence is executed if the amount of ink ejected from the recording head exceeds the predetermined value. Accordingly, both the first nozzle cover 43a and the second nozzle cover 43b on the outer sides of the ejection port surface can be properly wiped, thereby preventing a recording medium from being contaminated. The ink adhering to the nozzle cover 43 accumulates as the result that the recording head 40 repeatedly performs the recording operation multiple times. Even when the first nozzle cover 43a is less frequently wiped like the present embodiment, a recording medium can be sufficiently prevented from being contaminated.

In the above-described wide wiping sequence, the wiping is performed three times in the order of the first wiping operation, the second wiping operation, and the first wiping operation. Alternatively, the wiping may be performed two times in the order of the second wiping operation and the first wiping operation.

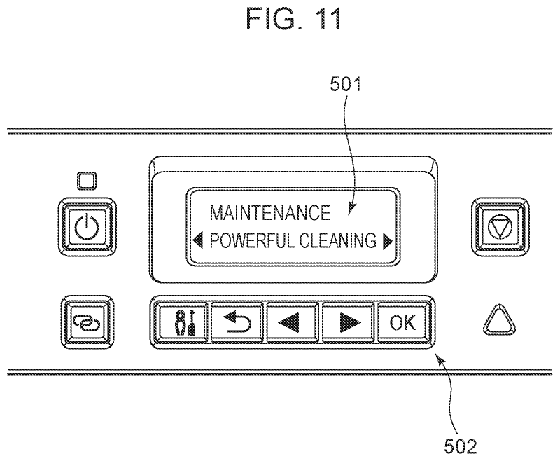

Furthermore, a user may execute the wide wiping sequence at a desirable timing. FIG. 11 illustrates a display panel of the recording apparatus 10. For example, when the user has found a contamination on a recording medium due to the ink or the like adhering to the nozzle cover 43 of the recording head 40, the user presses an operation button 502 and selects powerful cleaning from the menu displayed on a display 501. The second wiping operation may be executed in such a way. Note that the display 501 may be a touch panel. Furthermore, the recording apparatus 10 may receive an instruction of a cleaning process for performing the second wiping operation from a computer or a mobile terminal.

### Second Embodiment

In a second embodiment, an inkjet recording apparatus includes two recording heads, and the configuration of the inkjet recording apparatus is mainly described. Note that the wiping sequences and the control configuration are similar to those in the first embodiment, and the redundant description is omitted.

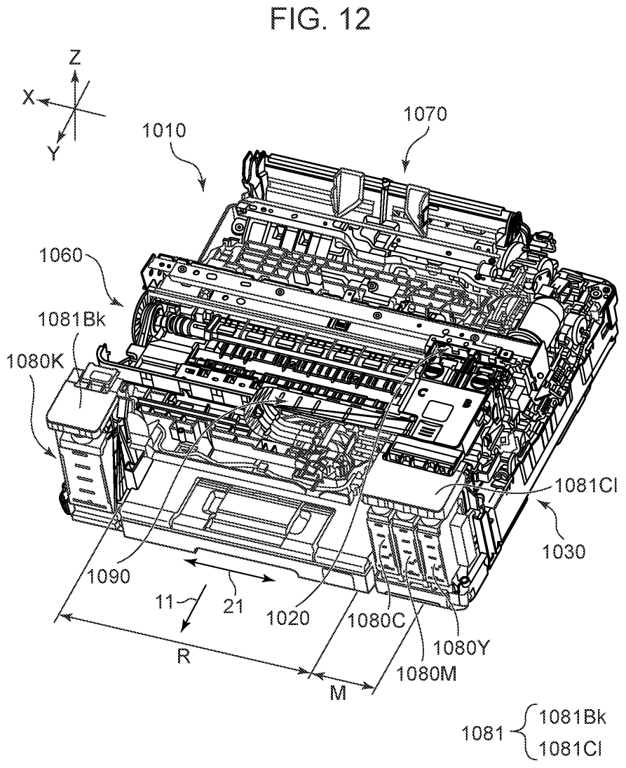

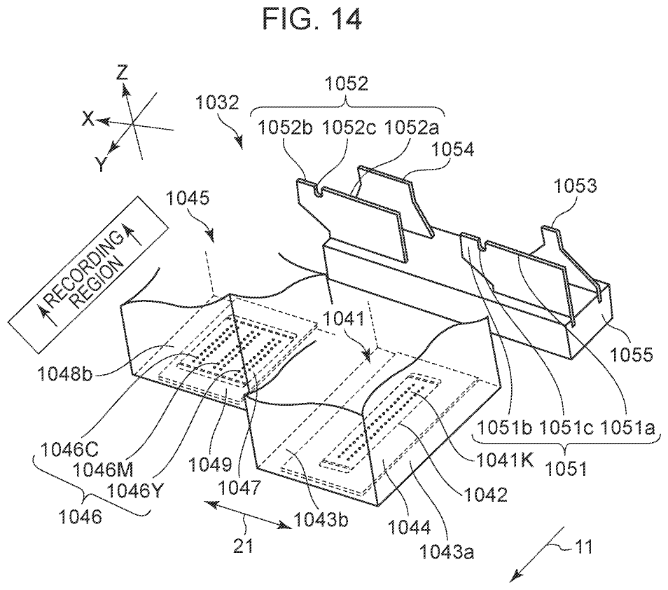

FIG. 12 is a schematic perspective view illustrating an overview of an inkjet recording apparatus (hereinafter, recording apparatus) 1010 according to the second embodiment. The recording apparatus 1010 includes a carriage 1020 on which a first recording head 1041 and a second recording head 1045 (see FIG. 14) are mounted, a feed unit 1070, a conveyance drive section 1060, and a maintenance unit 1030.

Unlike the first embodiment, the recording apparatus 1010 further includes an ink tank 1080 that houses ink to be supplied to the recording heads, and a tube 1090 for supplying the ink from the ink tank 1080 to the recording heads.

The ink tank 1080 is provided for each of colors of ink to be ejected from the recording heads. Each ink tank 1080 is fixed to a main body of the recording apparatus 1010. In the present embodiment, a black ink tank 1080K that houses black ink that is ejected from the first recording head 1041 is disposed on the left side when viewed from the front of the recording apparatus 1010.

A cyan ink tank 1080C that houses cyan ink, a magenta ink tank 1080M that houses magenta ink, and a yellow ink tank 1080Y that houses yellow ink are disposed on the right side when viewed from the front of the recording apparatus 1010. The second recording head 1045 can eject the cyan ink, the magenta ink, and the yellow ink.

The recording apparatus 1010 is also provided with a black tank cover 1081Bk and a color tank cover 1081C1. The black tank cover 1081Bk covers an upper surface of the black ink tank 1080K. The color tank cover 1081C1 collectively covers upper surfaces of the cyan ink tank 1080C, the magenta ink tank 1080M, and the yellow ink tank 1080Y.

The ink tank 1080 has an injection port (not illustrated), and is configured such that a user can inject ink into the ink tank 1080 from the injection port. When the user injects the ink, the user opens the tank cover 1081 to expose the injection port, and injects the ink from an ink bottle or the like housing the ink.

The arrangement and functions of the other components including the carriage 1020, the feed unit 1070, the conveyance drive section 1060, and the maintenance unit 1030 are similar to those of the first embodiment.

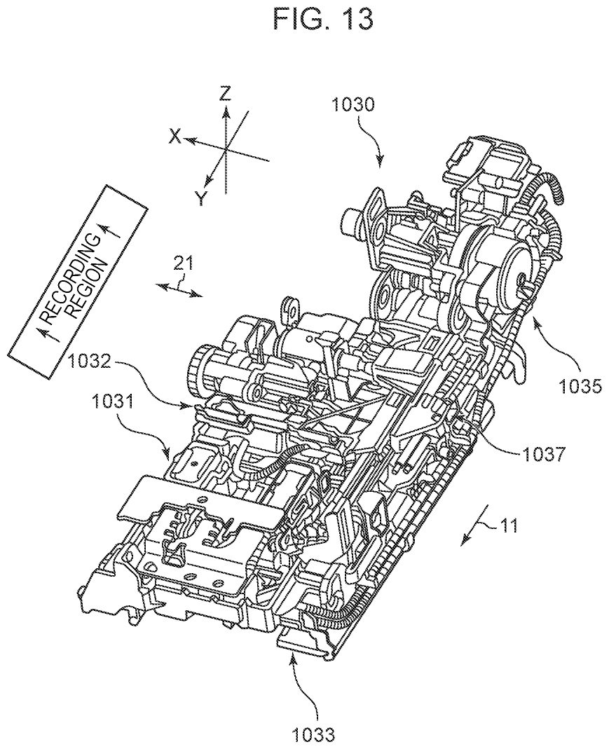

FIG. 13 is a perspective view of the maintenance unit 1030. Like the first embodiment, the maintenance unit 1030 includes a cap 1031, a wiper unit 1032, a cam slider 1033, a pump 1035, and an air valve lever 1037.

Since the two recording heads are mounted according to the second embodiment, the cap 1031 and the wiper unit 1032 are provided by two each to correspond to the recording heads. Like the first embodiment, in the maintenance unit 1030, since cam surfaces of the cam slider 1033 come into contact with follower surfaces of respective members by the operation of the cam slider 1033, the cap 1031, the wiper unit 1032, and the air valve lever 1037 are independently operated.

FIG. 14 is a perspective view illustrating correspondence between the wiper unit 1032, and the first recording head 1041 and the second recording head 1045. The first recording head 1041 includes an ejection port surface including a black chip surface 1042 having an ejection port array 1041K to eject the black ink and a black tab surface 1044 surrounding the periphery of the black chip surface 1042.

The first recording head 1041 further includes a first black nozzle cover 1043a and a second black nozzle cover 1043b that cover the outer sides of the black tab surface 1044 in the main scanning direction 21. The second black nozzle cover 1043b is disposed at a position closer than the first black nozzle cover 1043a to a recording region R (see FIG. 12) in the main scanning direction 21. The black nozzle cover 1043 has a lower surface that protrudes downward with respect to the black tab surface 1044. Thus, a step portion is provided between the black nozzle cover 1043 and the black tab surface 1044 in the gravity direction.

The second recording head 1045 includes a color chip surface 1047 having an ejection port array 1046C to eject the cyan ink, an ejection port array 1046M to eject the magenta ink, and an ejection port array 1046Y to eject the yellow ink. The second recording head 1045 includes a color tab surface 1049 surrounding the periphery of the color chip surface 1047. Hereinafter, the ejection port array 1046C, the ejection port array 1046M and the ejection port array 1046Y are also collectively referred to as an ejection port array 1046.

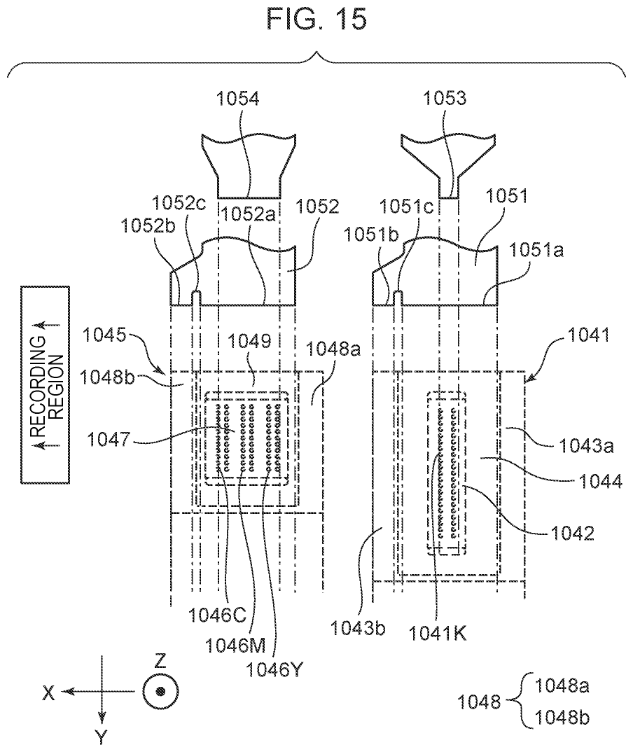

The second recording head 1045 further includes a first color nozzle cover 1048a (see FIG. 15) and a second color nozzle cover 1048b that cover the outer sides of the color tab surface 1049 in the main scanning direction 21. The second color nozzle cover 1048b is disposed at a position closer than the first color nozzle cover 1048a to the recording region R in the main scanning direction 21. The color nozzle cover 1048 has a lower surface that protrudes downward with respect to the color tab surface 1049. Thus, a step portion is provided between the color nozzle cover 1048 and the color tab surface 1049 in the gravity direction.

The wiper unit 1032 includes a first black wiper 1051, a first color wiper 1052, a second black wiper 1053, and a second color wiper 1054. Each wiper has a blade-like shape and is held by a wiper holder 1055.

The first black wiper 1051 includes a first contact portion 1051a, a second contact portion 1051b, and a notch 1051c. The second contact portion 1051b is provided on the side closer than the first contact portion 1051a to the recording region R. The notch 1051c is provided between the first contact portion 1051a and the second contact portion 1051b.

The first contact portion 1051a has a length in the main scanning direction 21 with which the first contact portion 1051a is capable of wiping the black tab surface 1044. The second contact portion 1051b has a length in the main scanning direction 21 with which the second contact portion 1051b is capable of wiping the second black nozzle cover 1043b.

The second black wiper 1053 is disposed upstream of the first black wiper 1051 in the conveyance direction 11. The second black wiper 1053 has a length in the main scanning direction 21 with which the second black wiper 1053 is capable of wiping the ejection port array 1041K.

The first color wiper 1052 includes a third contact portion 1052a, a fourth contact portion 1052b, and a notch 1052c. The fourth contact portion 1052b is provided on the side closer than the third contact portion 1052a to the recording region R. The notch 1052c is provided between the third contact portion 1052a and the fourth contact portion 1052b.

The third contact portion 1052a has a length in the main scanning direction 21 with which the third contact portion 1052a is capable of wiping the color tab surface 1049. The fourth contact portion 1052b has a length in the main scanning direction 21 with which the fourth contact portion 1052b is capable of wiping the second color nozzle cover 1048b.

The second color wiper 1054 is disposed upstream of the first color wiper 1052 in the conveyance direction 11. The second color wiper 1054 has a length in the main scanning direction 21 with which the second color wiper 1054 is capable of wiping all the ejection port arrays 1046C, 1046M, and 1046Y.

A first wiping operation and a second wiping operation according to the second embodiment are described next. The first wiping operation is a wiping operation that is performed when the first recording head 1041 and the second recording head 1045 are located at first positions. The second wiping operation is a wiping operation that is performed when the first recording head 1041 and the second recording head 1045 are located at second positions closer than the first positions to the recording region R.

FIG. 15 is a view schematically illustrating a moving path of the wiper unit 1032 when the first recording head 1041 and the second recording head 1045 are located at the first positions. The moving path of the wiper unit 1032 is indicated by one-dot chain lines.

When the first recording head 1041 is located at the first position, the first contact portion 1051a of the first black wiper 1051 faces the black tab surface 1044, and the second contact portion 1051b faces the second black nozzle cover 1043b. Thus, when the first wiping operation is performed, the first contact portion 1051a wipes the entirety of the black tab surface 1044, and the second contact portion 1051b wipes the second black nozzle cover 1043b.

Moreover, when the first recording head 1041 is located at the first position, the notch 1051c of the first black wiper 1051 faces the step portion between the black tab surface 1044 and the second black nozzle cover 1043b. Since the notch 1051c is provided, the first black wiper 1051 does not ride onto the second black nozzle cover 1043b due to the step portion, and the black tab surface 1044 can be properly wiped.

When the first recording head 1041 is located at the first position, the second black wiper 1053 faces the black chip surface 1042. Thus, when the first wiping operation is performed, the second black wiper 1053 wipes the black chip surface 1042.

Likewise, when the second recording head 1045 is located at the first position, the third contact portion 1052a of the first color wiper 1052 faces the color tab surface 1049, and the fourth contact portion 1052b faces the second color nozzle cover 1048b. Thus, when the first wiping operation is performed, the third contact portion 1052a wipes the entirety of the color tab surface 1049, and the fourth contact portion 1052b wipes the second color nozzle cover 1048b.

Moreover, when the second recording head 1045 is located at the first position, the notch 1052c of the first color wiper 1052 faces the step portion between the color tab surface 1049 and the second color nozzle cover 1048b. Since the notch 1052c is provided, the first color wiper 1052 does not ride onto the second color nozzle cover 1048b due to the step portion, and the color tab surface 1049 can be properly wiped.

When the second recording head 1045 is located at the first position, the second color wiper 1054 faces the color chip surface 1047. Thus, when the first wiping operation is performed, the second color wiper 1054 wipes the color chip surface 1047.

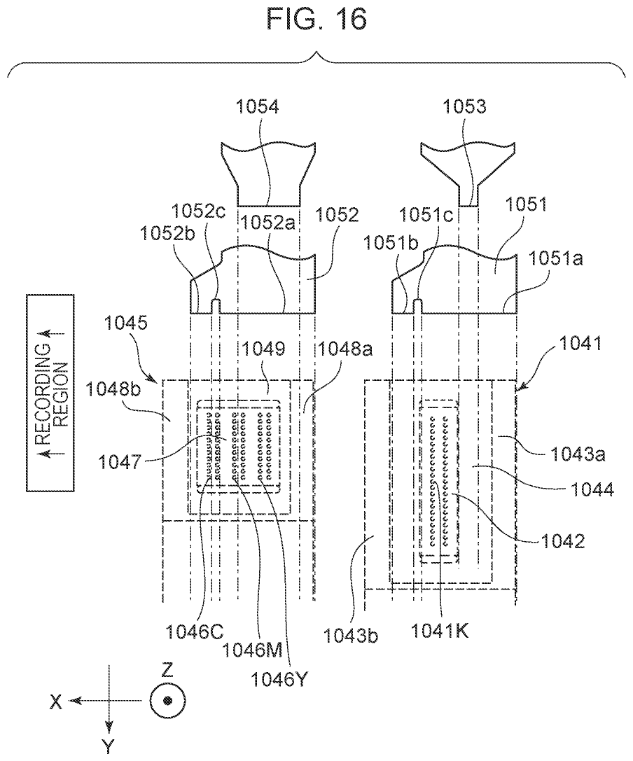

FIG. 16 is a view schematically illustrating a moving path of the wiper unit 1032 when the first recording head 1041 and the second recording head 1045 are located at the second positions. The moving path of the wiper unit 1032 is indicated by one-dot chain lines.

When the first recording head 1041 is located at the second position, a portion of the first contact portion 1051a of the first black wiper 1051 faces the first black nozzle cover 1043a. Thus, when the second wiping operation is performed, the first contact portion 1051a wipes the first black nozzle cover 1043a. That is, the first black nozzle cover 1043a that is not wiped by the first wiping operation is wiped by the second wiping operation.

Likewise, when the second recording head 1045 is located at the second position, a portion of the third contact portion 1052a of the first color wiper 1052 faces the first color nozzle cover 1048a. Thus, when the second wiping operation is performed, the third contact portion 1052a wipes the first color nozzle cover 1048a. That is, the first color nozzle cover 1048a that is not wiped by the first wiping operation is wiped by the second wiping operation.

With use of the above-described wiper unit 1032, a normal wiping sequence and a wide wiping sequence are executed like the first embodiment. Accordingly, the recording apparatus can be downsized, and wiping can be performed to the outer sides of the ejection port surface of the recording head.

That is, the present disclosure provides an inkjet recording apparatus capable of preventing a recording medium from being contaminated by performing wiping to an outer side of an ejection port surface.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A printing apparatus comprising:
a wiper unit having a wiper configured to wipe;
a carriage configured to move in a first direction with a print head, wherein the print head is mounted on the carriage, is configured to perform printing in a printing region, and has an ejection port surface that includes a plurality of ejection ports through which liquid is to be ejected; and
a controller configured to perform control for the wiper unit to execute a first wiping operation and a second wiping operation,
wherein the first wiping operation wipes the ejection port surface in a state where the print head is located at a print head first position, and the second wiping operation wipes the ejection port surface in a state where the print head is located at a print head second position closer to the printing region in the first direction than the print head first position, and
wherein the controller performs control so that the wiper unit sequentially executes, as a wiping sequence, the first wiping operation, the second wiping operation, and then the first wiping operation.

2. The printing apparatus according to claim 1, wherein the controller is configured to perform control so that the wiper unit executes the wiping sequence based on an amount of liquid ejected by the print head.

3. The printing apparatus according to claim 2, wherein, if an amount of liquid ejected by the print head since the wiping sequence of a last time exceeds a predetermined value, the controller performs control so that the wiper unit executes the wiping sequence.

4. The printing apparatus according to claim 1, wherein the controller is configured to perform control so that the wiper unit executes the wiping sequence based on a number of print medium printed by the print head.

5. The printing apparatus according to claim 4, wherein, if a number of print medium printed by the print head since the wiping sequence of a last time exceeds a predetermined number of print medium, the controller performs control so that the wiper unit executes the wiping sequence.

6. The printing apparatus according to claim 1,
wherein the print head has a first nozzle cover surface and a second nozzle cover surface, disposed on outer sides of the ejection port surface in the first direction, and
wherein the second nozzle cover surface is disposed at a position closer than the first nozzle cover surface to the printing region.

7. The printing apparatus according to claim 6, wherein the controller is configured to perform control such that the first wiping operation wipes the second nozzle cover surface but does not wipe the first nozzle cover surface, and the second wiping operation wipes the first nozzle cover surface but does not wipe the second nozzle cover surface.

8. The printing apparatus according to claim 6, wherein the controller performs control so that a notch included in the wiper faces a step portion between the ejection port surface and the second nozzle cover surface, in a state where the first wiping operation is executed.

9. The printing apparatus according to claim 6, wherein the second nozzle cover surface protrudes downward with respect to the ejection port surface.

10. The printing apparatus according to claim 1, wherein the controller is configured to control the wiper unit so that the wiper moves in a second direction intersecting with the first direction.

11. The printing apparatus according to claim 1, further comprising the print head.

12. A control method for a printing apparatus that includes a wiper unit having a wiper configured to wipe, and includes a carriage configured to move in a first direction with a print head, wherein the print head is mounted on the carriage, is configured to perform printing in a printing region, and has an ejection port surface that includes a plurality of ejection ports through which liquid is to be ejected, the control method comprising:
performing control for the wiper unit to execute a first wiping operation and a second wiping operation,
wherein the first wiping operation wipes the ejection port surface in a state where the print head is located at a print head first position, and the second wiping operation wipes the ejection port surface in a state where the print head is located at a print head second position closer to the printing region in the first direction than the print head first position; and
performing control so that the wiper unit sequentially executes, as a wiping sequence, the first wiping operation, the second wiping operation, and then the first wiping operation.

13. The control method according to claim 12, wherein performing control includes performing control so that the wiper unit executes the wiping sequence based on an amount of liquid ejected by the print head.

14. The control method according to claim 13, wherein, if an amount of liquid ejected by the print head since the wiping sequence of a last time exceeds a predetermined value, performing control includes performing control so that the wiper unit executes the wiping sequence.

15. The control method according to claim 12, wherein performing control includes performing control so that the wiper unit executes the wiping sequence based on a number of print medium printed by the print head.

16. The control method according to claim 15, wherein, if a number of print medium printed by the print head since the wiping sequence of a last time exceeds a predetermined number of print medium, performing control includes performing control so that the wiper unit executes the wiping sequence.

17. A non-transitory computer-readable storage medium storing a program to cause a computer to perform a control method for a printing apparatus that includes a wiper unit having a wiper configured to wipe, and includes a carriage configured to move in a first direction with a print head, wherein the print head is mounted on the carriage, is configured to perform printing in a printing region, and has an ejection port surface that includes a plurality of ejection ports through which liquid is to be ejected, the control method comprising:
performing control for the wiper unit to execute a first wiping operation and a second wiping operation,
wherein the first wiping operation wipes the ejection port surface in a state where the print head is located at a print head first position, and the second wiping operation wipes the ejection port surface in a state where the print head is located at a print head second position closer to the printing region in the first direction than the print head first position; and
performing control so that the wiper unit sequentially executes, as a wiping sequence, the first wiping operation, the second wiping operation, and then the first wiping operation.
